(19) United States
(12) Patent Application Publication
(10) Pub. No.: US 2016/0360025 A1
(43) Pub. Date: Dec. 8, 2016

(54) Health Status Communicator

(71) Applicant: Gary Lee Lockwood, Monument, CO (US)

(72) Inventor: Gary Lee Lockwood, Monument, CO (US)

(21) Appl. No.: 14/730,170

(22) Filed: Jun. 3, 2015

(51) Int. Cl. H04M 1/725; H04M 1/23; H04M 1/02

(52) U.S. Cl. CPC H04M 1/72541; H04M 1/72594; H04M 1/0283; H04M 1/72552; H04M 1/23; H04M 1/72569; H04M 1/7255

(57) ABSTRACT

This invention is an electronic device that prompts the user to communicate their overall health status to loved ones or friends with a simple touch of a button. This device makes it easy for the user to let others know whether they are feeling well, need monitoring, or are in need of immediate help by sending predefined or customizable messages associated with individualized colored buttons. The device prompts the user at a predetermined time with a flashing light, buzzer, or both, to communicate their status. The user communicates their status by pressing one of three color-coded buttons. Once a color-coded button is pressed, the status communication(s) are sent via email, text, and/or audio message to the designated individuals. The device disclosed herein completes this mission via its ability to send an email, text message and/or audio message to the concerned parties by simply pressing the appropriate color-coded button.

### BACKGROUND OF THE INVENTION

There are many people living alone for whom their loved ones and friends are concerned about their well-being. In November of 2013 my brother-in-law, Jerry, who was living alone, tripped and fell inside his apartment and was knocked unconscious. Jerry was found dead days later. Perhaps Jerry would be alive today if he had arranged to consistently communicate his well-being to at least one friend and/or loved one. His lack of communication would have alerted him or her to a potential problem.

The US Census Bureau's research shows that, as of 2012, 27 percent of Americans live alone, which is more than one in four households and approximately 33.2 million people. One of those is my brother, David. Being concerned that he could potentially suffer Jerry's fate, we arranged for him to send me an email every day to let me know he was okay. Naturally, he forgot on the very first day. That led to the creation of my invention, a simple device to remind people to communicate their status to at least one friend, neighbor, or loved one every day or at whatever intervals make sense for them.

There are several devices on the market that attempt to address the needs of individuals in an emergency situation by allowing them to proactively communicate a problem once an emergency situation has occurred. These devices simply do not work if the individual is unable to perform the task necessary to communicate the emergency and depend on conscious activity. This invention is not designed to compete with this market. This device is designed to facilitate regular communication to loved ones that the individual is “okay.” By the simple fact that the user has NOT pressed a button on the device to communicate their status will alert their loved ones to the fact that there may be a problem and they may need to initiate help for the user.

To emphasize this point, the purpose of this device is to provide peace of mind to friends and loved ones. Regular and ongoing communication that is as simple as pressing a button is the key to this peace of mind.

### BRIEF SUMMARY OF THE INVENTION

This invention is a small electronic device enabling the user to easily inform their loved ones and/or friends of their subjective health status in order to ease the minds of these friends and loved ones. This invention makes it quick and easy for the user to let others know whether they are feeling well, need monitoring, or are in need of help via predefined or customizable messages associated with a colored and varied-size series of buttons on the device.

The device disclosed herein completes this mission via its ability to send an email, text message and/or audio message to the friends and/or loved ones by simply pressing the appropriate color-coded and sized button. The device prompts the user with a flashing light, buzzer, or both to communicate their status. The prompts can be independently configured to activate at predefined times of the day or predefined intervals. The user communicates their status by pressing one of three color-coded and varying sized buttons. Once a color-coded button is pressed, the status communication(s) are sent via email, text, and/or audio message to the designated individuals. The number of recipients and the type of message (i.e. email, text or audio) sent is user-configurable associated with the color and size of the button pressed. The context of each message is configurable based on the color of the button pressed, the message type, and the individual recipient.

For ease of use, the device has only three buttons in which the user interacts. The button colors are red, yellow, and green, which are similar to the colors of the lights an individual would find on most traffic signals throughout the world. When displayed together, the meaning of these colors are universally understood—red signifies “stop” or “danger”; yellow signifies “caution;” and green signifies “go” or “proceed” (everything is okay). For individuals who are color-blind or have a visual impairment, the buttons vary in size and/or may have embossing or brailling. In a typical application, a person living alone would position the device in a prominent location within their dwelling, such as the kitchen counter. At a predetermined time, the device would remind the user by way of a flashing light, buzzer, or both, to communicate their health status to friend(s) or loved one(s) by simply pressing one of the three buttons. To easily communicate that they are doing fine, the green button would typically be configured to send a message stating, “I am feeling fine. Have a nice day.” The yellow button would typically be configured to send a message stating, “I′m not feeling that good, please check on me later.” And the red button would typically be configured to send a message stating, “I need immediate help!” It is vital to emphasize once again that this invention is mostly concerned with the user pressing the green button to regularly communicate to their loved ones that they are “okay.” It is a peace of mind device to help alleviate worry the loved ones have for the user. The option of additional buttons on the device allows the user to communicate their health status at a more granular level. In the event of an emergency, the user should dial 911 instead of using this device.

It is important to note that the color, the number, and the size of the buttons are not critical or specific to this invention. There could be applications for the device that would call for a different number, color, and/or size of buttons.

In one embodiment, the current invention relates to a system having wired and wireless interfaces to enable it to communicate the user's status via Internet communications.

In another embodiment, the current invention relates to a system having a voice modem interface to enable it to communicate the user's status via a standard telephone line (land-line).

In another embodiment, the current invention relates to a system having a cellular interface to enable it to communicate the user's status via cellular communications.

In typical embodiment, the current invention relates to a system having three buttons for the user to press to communicate their status.

In another embodiment, the current invention relates to a system having one or more buttons for the user to communicate his or her status.

Due to the ease at which the device can be configured, I anticipate it being used for several diverse applications. The following list a few of the anticipated applications.

### Person Living Alone Application—(Primary):

The primary function of this device is to let loved ones know the user is “feeling fine” and therefore there is no need to worry about them.

Designed to be simple to use and understood, the device/app will have one flashing light, a buzzer, and three different colored buttons. There is a green button to indicate the user is okay and doing fine. There is a yellow button to indicate the user is not feeling well and the loved one may want to check on them later in the day. There is a red button to indicate the user is in need of help.

Ideally the device will be placed on the kitchen counter or on a nightstand next to the user's bed. Each morning a light on the device will flash at a rate of approximately one flash every second to remind the user to select and press one of the three buttons to send a message to their loved ones as to how they are feeling. The user will press the green button to send a message indicating they are feeling fine and their loved ones have no need to worry. The user will press the yellow button to send a message indicating they are not feeling well and their loved ones may want to check in on them later. The user will press the red button to send a message indicating they need immediate help.

The context of the messages, the number of messages sent, the flashing of the light, and the sounding of the buzzer are totally configurable by the user.

### Babysitter Application:

Since the context of the messages are completely configurable, the device is suitable for many different applications. For instance, the device can be configured by concerned parents to be used by a babysitter. Wouldn't it be comforting for a parent to receive a text message every hour on the hour from the babysitter indicating everything is fine with their child or children. The flashing light and buzzer can be configured to go off every hour reminding the babysitter to press one of the buttons indicating the kid(s) are okay, there is concern, or s/he is in need of help.

### College Student Application:

This application is very similar to the primary application for the device. The concept is that the device would be set up in a student's college dorm room thereby making it extremely easy for the student to let his or her worried parents know that s/he is okay. Since the majority of the time the parents are paying for the kids college education, they would be able to “pressure” the student into complying with their request to be informed as to the welfare of their child.

### BRIEF DESCRIPTION OF DRAWINGS

FIG. 1 is a diagram illustrating the preferred embodiment of the current invention.

FIG. 2 is a diagram illustrating an alternative embodiment of the current invention depicting the device with three color-coded buttons of the same size arranged in the order of green, yellow and red.

FIG. 3 is a diagram illustrating another alternative embodiment of the current invention depicting the device with a single large green button.

FIG. 4 is a schematic diagram illustrating the invention with an Ethernet interface and how it will deliver email and text messages.

FIG. 5 is a schematic diagram illustrating the invention with an Wi-Fi interface and how it will deliver email and text messages.

FIG. 6 is a schematic diagram illustrating the invention with a cellular interface and how it will deliver email, text and audio messages.

FIG. 7 is a schematic diagram illustrating the invention with a voice modem interface and how it will deliver email, text and audio messages.

### DETAILED DESCRIPTION OF THE INVENTION

Before describing how the present invention achieves the aforementioned user prompts and the sending of various message types, it is instructive to describe in detail the various hardware modules. After which how the device utilizes the modules to achieve the results of the invention can more easily be described.

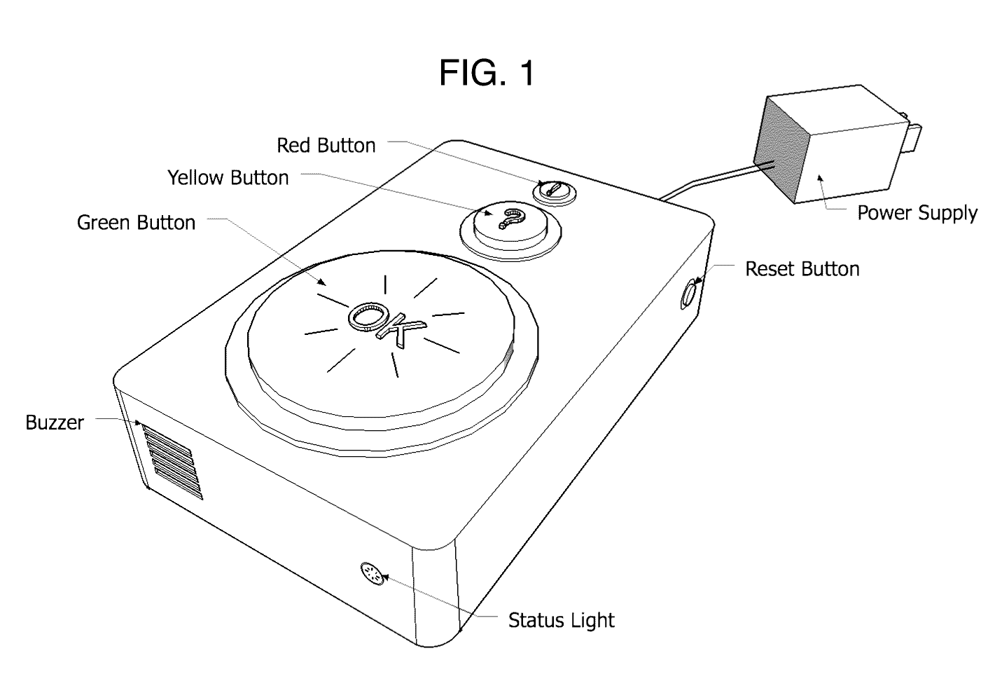

FIG. 1 is a diagram illustrating the preferred embodiment of the current invention depicting the number of buttons and their size, color, labeling, and orientation on the device. It also depicts the inclusion of the status light, buzzer, reset button, and the power-supply. As aforementioned, the actual size of the device; the number, size, color, orientation, labeling, embossing, and brailling of the buttons; the location of the lights; and the location of the power source is not critical to the intended function of the invention. This diagram depicts the invention with three color-coded buttons arranged by size with the green being the largest and the red being the smallest. It also depicts the large green button having the ability to flash as the user prompt.

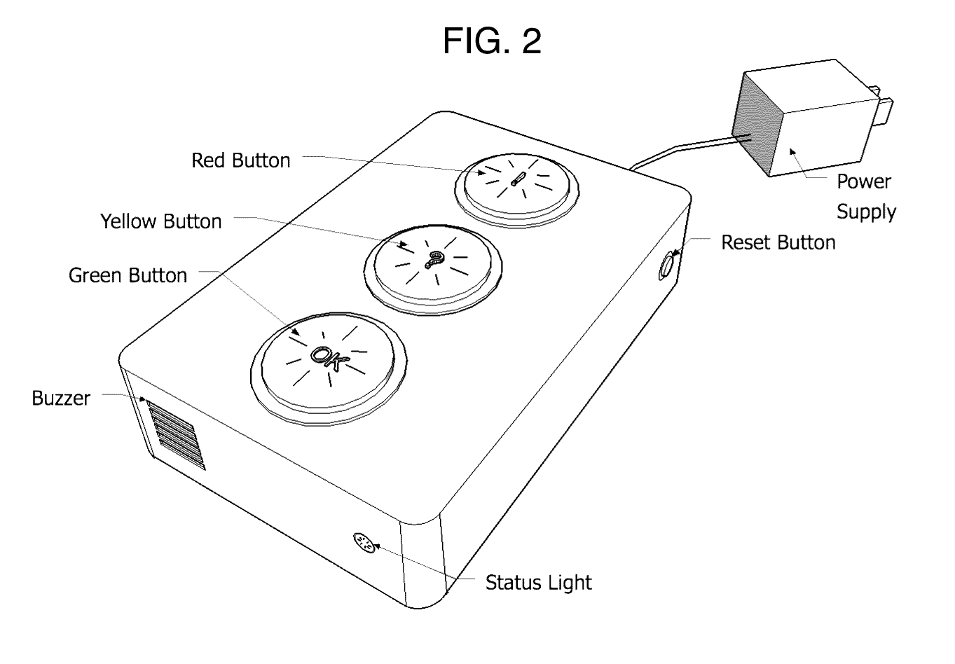

FIG. 2 is a diagram illustrating an alternative embodiment of the current invention depicting the device with three color-coded buttons of the same size arranged in the order of green, yellow and red. It also depicts all three buttons having the ability to flash as the user prompt. Additionally, it depicts the inclusion of the status light, buzzer, reset button, and the power-supply.

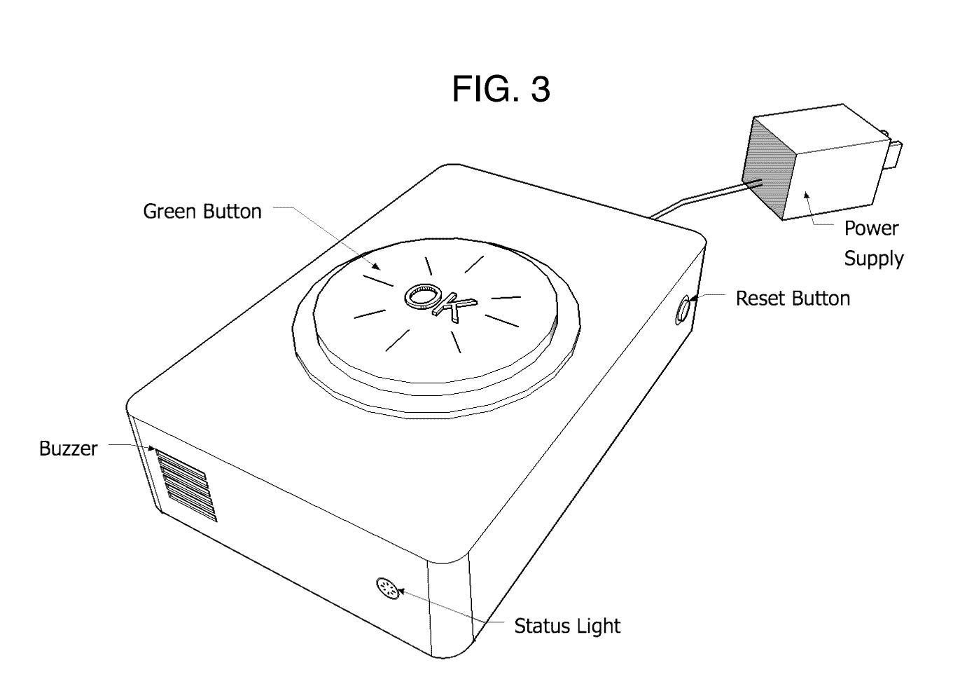

FIG. 3 is a diagram illustrating a second alternative embodiment of the current invention depicting the device with a single large green button. It also depicts this button as having the ability to flash as the user prompt. Additionally, it depicts the inclusion of the status light, buzzer, reset button, and the power-supply.

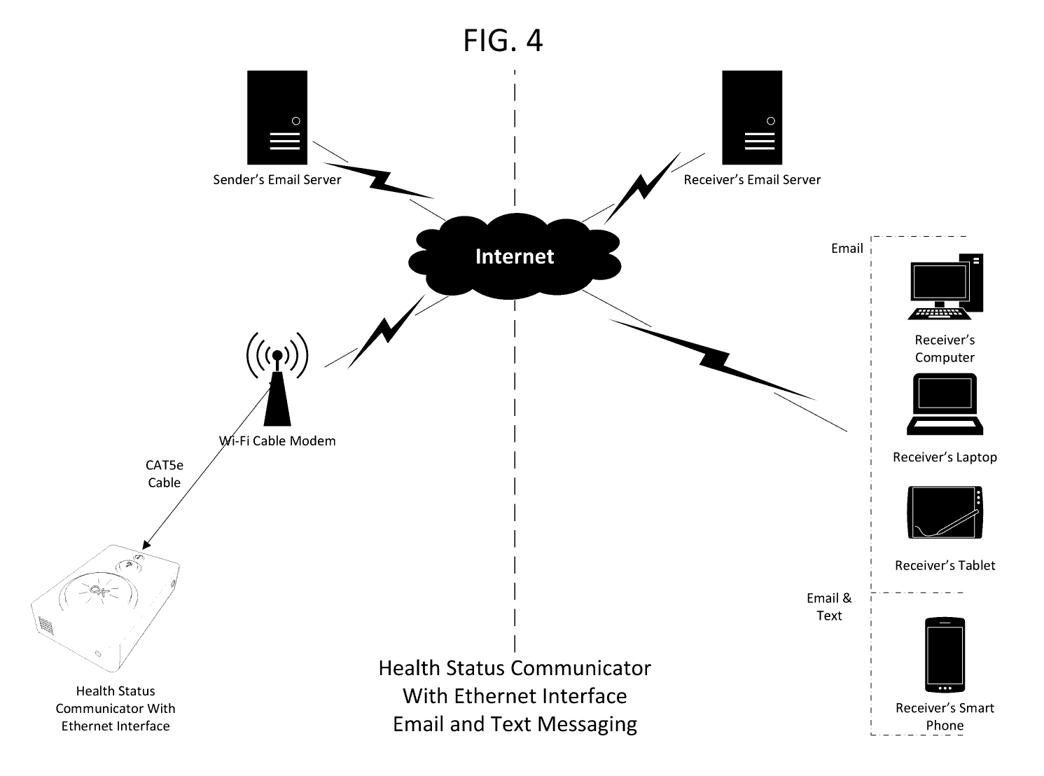

FIG. 4 is a schematic diagram illustrating how the invention will send email and/or text messages using the Ethernet interface. In this configuration the user will connect the device to a cable or DSL modem with an Ethernet (i. e. CAT5e) cable. The cable or DSL modem connection provides the device a path to the Internet whereby it can send the emails and/or text messages. To send an email message the device will transmit the message to the user's preferred email server via SMTP. The email server will then forward the message to the recipient's email server. The recipient will then retrieve the message using any number of methods including a web interface or a PC, tablet, or smart-phone application.

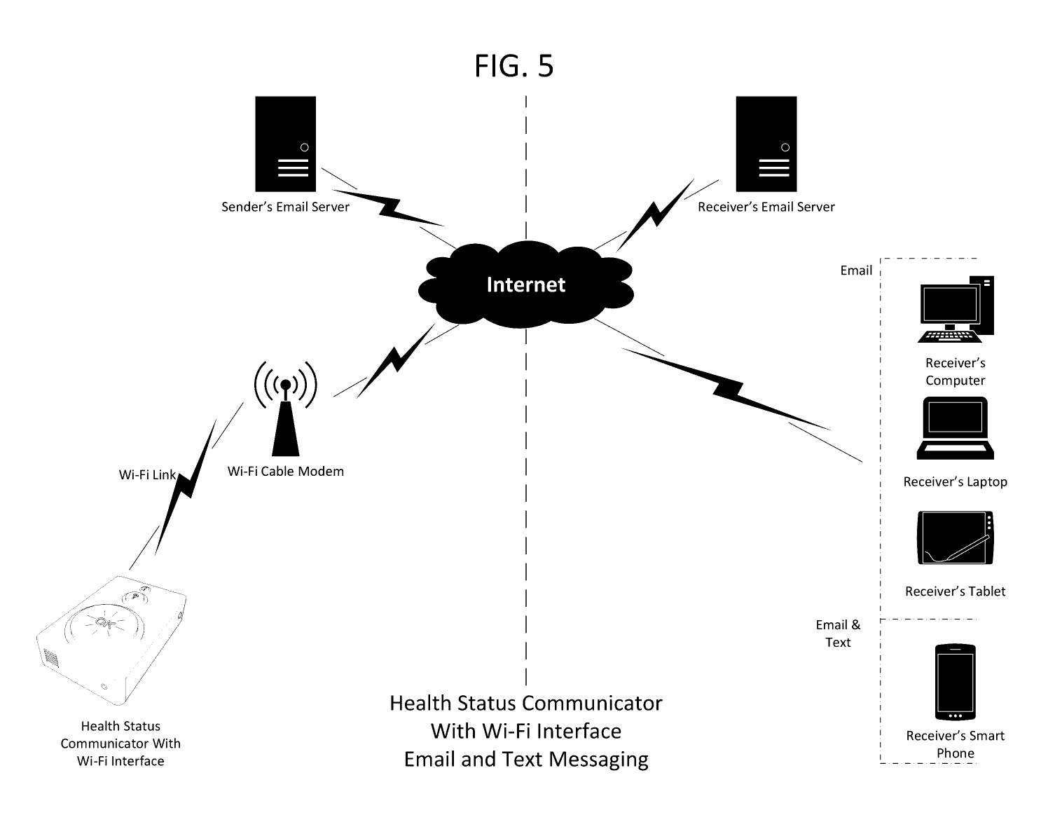

FIG. 5 is a schematic diagram illustrating how the invention will send email and/or text messages using the Wi-Fi interface. In this configuration the user will connect the device to the Internet by configuring the device's Wi-Fi interface to access and connect to their Wi-Fi access point. The Wi-Fi access point may be a stand-alone device, built into a router, or built into their cable or DSL modem. In this diagram the Wi-Fi access point is depicted as being built into the user's cable modem. This provides a path to the Internet whereby the device can send emails and/or text messages. To send an email message, the device will transmit the message to the user's preferred email server via SMTP. The email server will then forward the message to the recipient's email server. The recipient will then retrieve the message using any number of methods including a web interface or a PC, tablet, or smart-phone application.

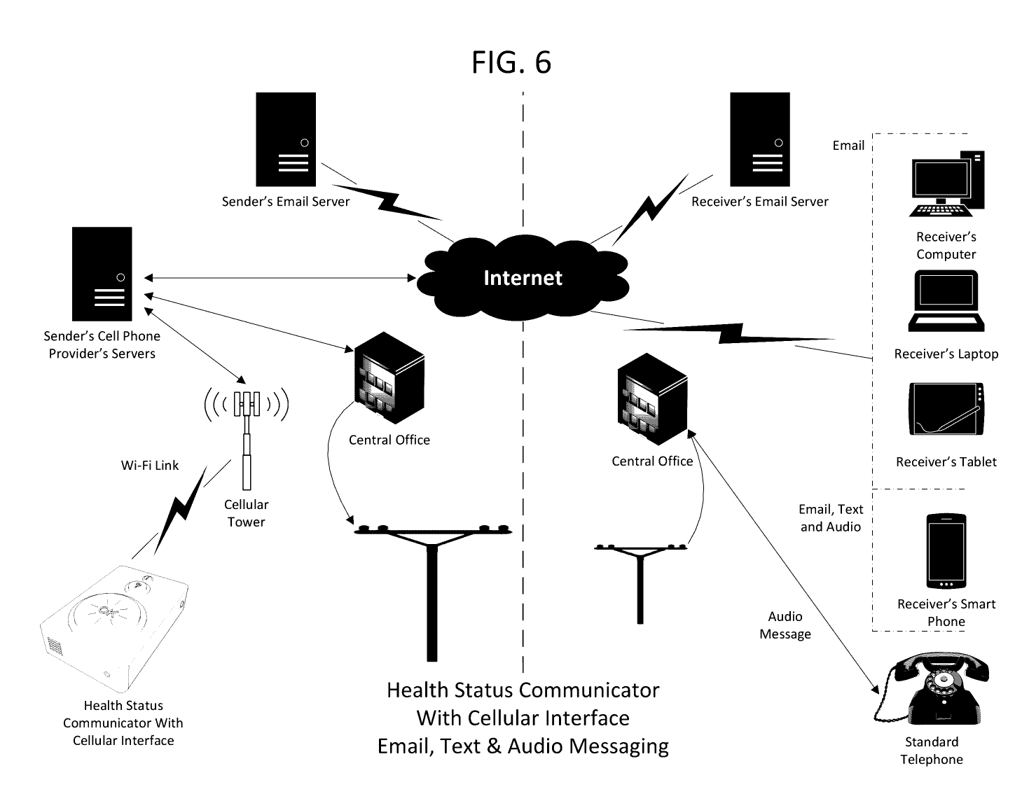

FIG. 6 is a schematic diagram illustrating how the invention will send email, text, and/or audio messages using the cellular interface. In this configuration the user will configure the device's cellular interface to access and connect to their cellular service provider. This method provides a path to the Internet whereby the device can send the emails and/or text messages. To send an email message, the device will transmit the message to the user's preferred email server via SMTP. The email server will then forward the message to the recipient's email server. The recipient will then retrieve the message using any number of methods including a web interface or a PC, tablet, or smart-phone application. The connection to the cellular service provider also provides a path whereby the device can send prerecorded audio messages by direct-dialing the recipient's phone number. The recipient of an audio message would receive a call on their phone and upon answering the call, the device will play the prerecorded audio message.

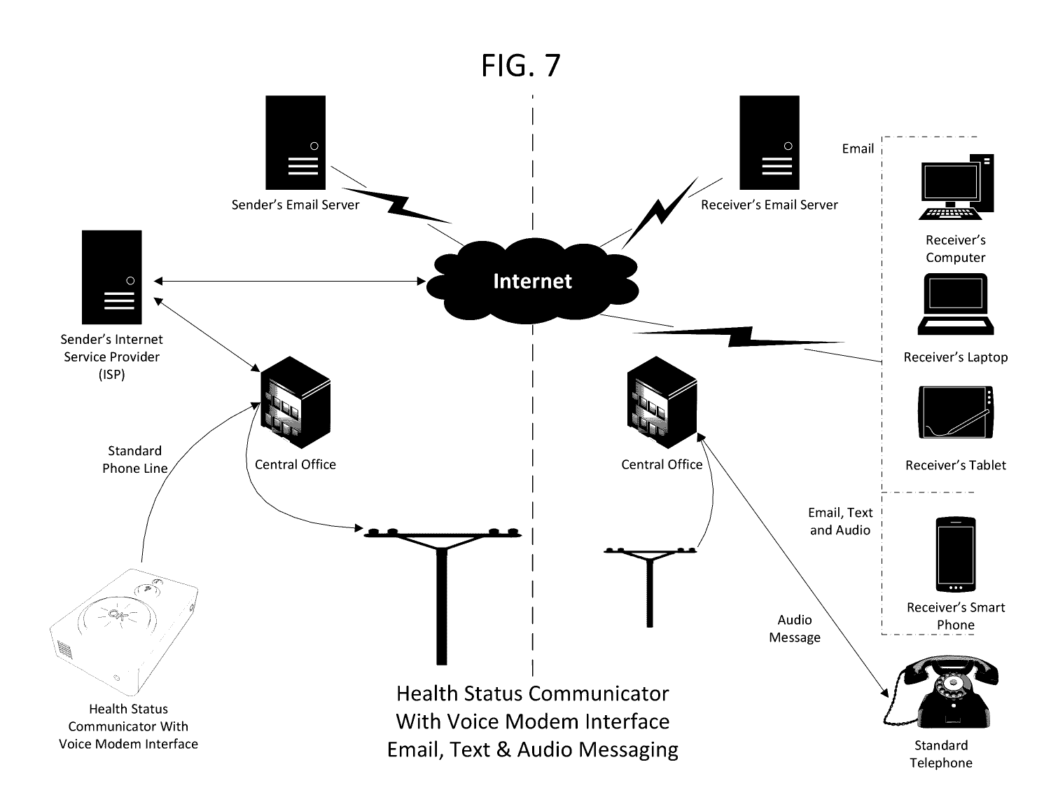

FIG. 7 is a schematic diagram illustrating how the invention will send email, text, and/or audio messages using the voice modem interface. In this configuration the user will connect the device to a standard telephone jack using a standard phone cable. The user will configure the voice modem to dial and connect to their Internet Service Provider (ISP). This provides a path to the Internet whereby the device can send the emails and/or text messages. To send an email message, the device will transmit the message to the user's preferred email server via SMTP. The email server will then forward the message to the recipient's email server. The recipient will then retrieve the message using any number of methods including a web interface or a PC, tablet, or smart-phone application. Additionally, the voice modem connection to a standard telephone jack provides a path whereby the device can send prerecorded audio messages by direct-dialing the recipient's phone number. The recipient of an audio message would receive a call on their phone and upon answering the call, the device will play the prerecorded audio message.

This invention is a small intelligent electronic device enabling the user to easily communicate their subjective health status to their loved ones and/or friends in order to provide them with peace of mind related to the user's health. Physically the device consists of a small enclosure, a single board computer (SBC), buttons, an audible buzzer, LEDs/lights, input/output interfaces, and a power source. The SBC provides the intelligence. The buttons provide user input. The buzzer provides an audible output. The LEDs/lights provide the visual output. The input/output interfaces provide the necessary connectivity. And the power source provides the power needed for the device to operate properly.

The intelligence is provided by a single board computer (SBC). This may consist of a system on a chip (SoC), a micro-controller, microprocessor, or any combination of these intelligent processing devices. The SBC includes the required memory and supporting circuitry to enable the device to run its programs allowing it to function as designed. The SBC and its supporting circuitry and software will herein be referred to as “the system.”

The system uses a configuration file to determine the following: 1) who should receive messages based on the button pressed, 2) what type of message to send to the recipient (email, text, or audio), 3) what the context of the message will be, based on the button pressed, the type of message being sent, and the intended recipient, 4) how to configure the input/output interface in order to enable message communication based on the interface being used, 5) when the LEDs/lights should light and/or flash, 6) when the buzzer should sound, 7) where to find and play the audio files based on what button was pressed, and the intended recipient.

The user will provide input to the system by pressing one of the buttons on the device. Minimally, the device will have a single button allowing the user to communicate to their loved-ones that they are “okay.” The preferred embodiment of the invention will consist of three buttons allowing the user to easily communicate multiple health statuses. In this embodiment, the buttons are color-coded, labeled, and arranged in such a manner as to make it easy for the user to understand their meaning and intended purpose. The green, yellow, red color-coding is universally understood by most individuals to mean “Go” or “OK” for green, “Caution” or “I′m not feeling good” for yellow, and “Stop” or “I need help” for red. The number, size, labeling, embossing, brailling, and orientation of the buttons is not critical to the functionality of this invention. The number of buttons corresponds to the level of detailed communication the user can easily provide to the recipients. The device may have an optional reset button enabling the user to force the system to reboot and reconfigure itself.

The device has one or more LEDs used as lights to prompt the user to press a button or to indicate the system's status. The system will use the configuration file to determine when and/or at what intervals to flash the LEDs/lights to prompt the user to press a button. The LEDs/lights may exist within the buttons and/or be separately mounted to the device. There may be an LED used as a system status indicator to indicate to the user that the system is in the process of booting up and configuring itself, the system is having a problem, and/or the system is functioning properly and the power is on.

The device may also have an audible buzzer used to prompt the user to press a button. The system will use the configuration file to determine when and/or at what intervals to sound the buzzer to prompt the user to press a button. The configuration of the LEDs/lights and the buzzer can be independent or they can be linked in order to provide an escalating user prompt.

The device has one or more of four different input/output interfaces. These interfaces consist of an Ethernet port, a Wi-Fi module, a voice modem, and a cellular module. The system will utilize the Ethernet port to connect to the user's network via an Ethernet cable (such as a Cat 5e or Cat 6 cable). The system will utilize the Wi-Fi module to connect to the user's wireless access point. The system will utilize the voice modem to connect to the user's standard telephone line. The system will utilize the cellular module to access the user's cellular service provider. The system will use the configuration file to configure the appropriate input/output interface.

The system will utilize an Internet connection provided by one of the input/output interfaces to send the email and text messages. The system may also be configured to send an audio message as an email attachment. The system will utilize the voice modem or cellular interfaces to deliver audio messages by way of direct dialing the recipient's phone number.

This invention will also have a power source capable of providing the electrical power necessary for the system to function properly. The power source will be capable of being connected to most standard household power outlets throughout the world. These power outlets include 120V and 230V outlets in the United States and Europe respectively. In addition, the device may optionally be configured to use a battery as its sole power source or as a backup in case of a power outage.

What is claimed:

1. An electronic communication device, powered by standard household electrical circuit and/or battery; such that typical household voltages and frequencies in the USA and Europe are 120V at 60 Hz and 230V at 50 Hz, respectively.

2. Wherein such device in claim 1 provides a visual and/or audio prompt to the user at predefined times.

3. Whereas the prompts in claim 2 consist of a flashing light or lights, a buzzer, or both.

4. Whereas the prompts in claim 2 exist to remind the user to press one of the color-coded buttons on the device thereby causing the device to send the predefined messages associated with the button pressed.

5. Whereas the pressing of the appropriate button in claim 4 causes the device to communicate the user's overall health status to those concerned.

6. Whereas the prompts in claim 2 are independently configurable from one another.

7. Whereas the prompts in claim 2 may be configured for set times of the day, at user defined intervals, or they can be linked in order to provide an escalating user prompt.

8. Whereas such device in claim 1 has one or more buttons for user input.

9. Whereas the button(s) in claim 8 are color-coded.

10. Whereas the color-coded button(s) in claim 9 will typically be the universally understood colors of red, yellow and green.

11. Whereas the color red in claim 10 is understood to signify “stop” or “emergency.”

12. Whereas the color yellow in claim 10 is understood to signify “caution” or “a potential problem.”

13. Whereas the color green in claim 10 is understood to signify “go” or “everything is okay.”

14. Whereas the button(s) in claim 8 are also arranged by size.

15. Whereas the size of the green button in claim 10 is the largest as it should be the most often used of the three buttons.

16. Whereas the size of the yellow button in claim 10 is smaller than the green button.

17. Whereas the size of the red button in claim 10 is the smallest.

18. Whereas the arrangement of the buttons in claim 14 is to facilitate the use of the device by color-blind individuals or those with visual impairments.

19. Whereas the buttons in claim 8 may be labeled, embossed, and/or brailled in such a manner as to help facilitate its use by color-blind individuals or those with visual impairments.

20. Whereas the number of, color, size, labeling, embossing, brailling, and arrangement of the button(s) in claims 8-19 is not critical to the function of the device and there may be applications for the device where these attributes would change.

21. Whereas such device in claim 1 is capable of sending three different message types.

22. Whereas the types of messages in claim 21 are email, text and audio messages.

23. Whereas the delivery methods for the messages in claim 21 consist of the Internet, cellular phone service, or standard telephone line (land line).

24. Whereas the Internet delivery method in claim 23 is utilized to send email and/or text messages.

25. Whereas the cellular phone service delivery method in claim 23 is utilized to send email, text, and/or audio messages.

26. Whereas the standard telephone line delivery method in claim 23 is utilized to send email and/or text messages via a dial-up Internet Service Provider (ISP) and audio messages via direct dialing the recipient.

27. Whereas the context of messages in claim 21 is either predefined or configurable by the user.

28. Whereas the context of messages in claim 21 is associated with the color of the button pressed.

29. Whereas the context of messages in claim 21 is configurable by the color of the button pressed, the type of message being sent, and recipient receiving the message.

30. Whereas any recipient of any message type in claim 21 could have unique context.

31. Whereas the messages in claim 21 have predesignated, configurable recipients.

32. Whereas the recipients in claim 31 are defined during the configuration of the device.

33. Whereas such device in claim 1 may be configured to automatically generate and send a message to predefined recipients when the user has not responded to the prompts within a predefined amount of time.

34. Whereas such device in claim 1 has the option of hardware modules, a status light(s), and a reset button.

35. Whereas one of the hardware modules in claim 34 consists of an Ethernet interface to facilitate email and text messaging via the Internet.

36. Whereas another of the hardware modules in claim 34 consists of a Wi-Fi adapter to facilitate email and text messaging via the Internet.

37. Whereas another of the hardware modules in claim 34 consists of an optional cellular phone module to facilitate email, text, and audio messaging.

38. Whereas another of the hardware modules in claim 34 consists of an optional voice modem interface to facilitate email, text messaging by way of a dial-up ISP, and audio messaging via direct dialing.

39. Whereas the status light in claim 34 is used to indicate the status of the device at any point in time.

40. Whereas the status light in claim 34 is used to indicate that the device is booting up and in the process of configuring itself.

41. Whereas the status light in claim 34 is used to indicate that the device is powered on and working properly.

42. Whereas the status light in claim 34 is used to indicate that the device has a problem such as being unable to access the Internet or unable to access a cellular phone service.

43. Whereas the reset button in claim 34 is used to force a reboot of the device and allow it to reconfigure itself.

44. Whereas such device in claim 1 has multiple configurations that may be set by the user.

45. Whereas one of the configurations to be set in claim 44 is the timing of the prompts referred to in claim 2.

46. Whereas the configuration of the prompts in claim 44 is related to the flashing light(s) and the audible buzzer.

47. Whereas the configuration of the prompts in claim 44 may be set to activate at a particular time of the day, at regular intervals, or in relationship to one another.

48. Whereas the configuration of the prompts in claim 44 may be set independently of one another such that they may be activated together or separately.

49. Whereas another configuration to be set in claim 44 is the messages.

50. Whereas the message configuration in claim 49 facilitates the context of the messages to be configurable.

51. Whereas the message configuration in claim 49 is used to associate the context of a message with the color of the button pressed, the type of message being sent and the recipient.

52. Whereas the message configuration in claim 49 may be set to automatically generate and send a message to a set of recipients if the user has not responded to the prompts within a certain amount of time.

53. Whereas another of the configurations to be set in claim 44 is the email server configuration used by the device to send emails and text messages.

54. Whereas another of the configurations to be set in claim 44 is the cellular phone service configuration used by the device to send emails, text, and audio messages.

55. Whereas another of the configurations to be set in claim 44 is the voice modem to ISP configuration used by the device to send email and text messages via an ISP.

56. Whereas the email message in claim 22 may consist of an email with an audio file attachment.
